(19) United States
(12) Patent Application Publication
(10) Pub. No.: US 2014/0326845 A1
(43) Pub. Date: Nov. 6, 2014

(54) Device for holding an electronic apparatus

(71) Applicant: Portia International Trading Limited, Hong Kong (HK)

(72) Inventor: Siu Lung Jeffrey Lui, Hong Kong (HK)

(73) Assignee: Portia International Trading Limited, Hong Kong (HK)

(21) Appl. No.: 14/109,957

(22) Filed: Dec. 18, 2013

(30) Foreign Application Priority Data
Dec. 20, 2012 (HK) 12113220.1

(51) Int. Cl. F16M 11/20

(52) U.S. Cl. CPC F16M 11/2092; F16M 2200/08
USPC 248/346.03

(57) ABSTRACT

The present invention relates to a device for holding an electronic apparatus comprises a body and a mounting means, the said body comprises a supporting structure adapted for receiving the electronic apparatus, the said mounting means adapted for being moved between a first and second positions of the said body is mounted to the said body, a first face of the said mounting means is protruded from a face of the said supporting structure when the said mounting means is at the first position of the body, the said mounting means is adapted to be received inside the said body when the said mounting means is at the second position of the said body, the said supporting structure comprises a supporting face mounting to a lower face of the said supporting structure, the said supporting face is adapted for supporting the electronic apparatus.

### TECHNICAL FIELD

The present invention relates to the peripheral field of electronic apparatus, and in particular, the present invention relates to a device for holding an electronic apparatus.

### BACKGROUND OF THE INVENTION

An electronic apparatus holder is used for holding an electronic apparatus. The existing electronic apparatus holder usually has a fixed mounting means. When the electronic apparatus is mounted in the electronic apparatus holder, the mounting means of the electronic apparatus may be inserted into an interface of the electronic apparatus to implement communications or charging. Since the mounting means is protruded from a face of the electronic apparatus holder, the electronic apparatus can only be mounted into the electronic apparatus holder through a side face having the interface, which is inconvenient for a user to use. Therefore, an improved electronic apparatus holder is needed in urgent.

### SUMMARY OF THE INVENTION

The problem to be solved in the present invention is to provide a device for holding and charging an electronic apparatus. Another problem to be solved in the present invention is to provide a device for an electronic apparatus to rest on a planar surface and charge the apparatus on the same surface of the device. Another problem to be solved in the present invention is to provide a battery charging element adapted to be received inside the device for holding an electronic apparatus.

A device for holding an electronic apparatus comprises a body and a mounting means, the said body comprises a supporting structure adapted for receiving the electronic apparatus, the said mounting means adapted for being moved between a first and second positions of the said body is mounted to the said body, a first face of the said mounting means is projected from a face of the said supporting structure when the said mounting means is at the first position of the body; the said mounting means is received inside the said body when the said mounting means is at the second position of the said body, the said supporting structure comprises a supporting face mounting to a lower face of the said supporting structure, the said supporting face is adapted for supporting the electronic apparatus.

In an embodiment, the said supporting structure comprises a lower face adapted for supporting the electronic apparatus, the said mounting means is protruded from the said lower face when the said mounting means is at the first position.

In an embodiment, the angle formed between the said lower face and said supporting face is substantially equal to or larger than 90 degrees.

In an embodiment, the said supporting face comprises an aperture adapted for allowing the said mounting means to pass through.

In an embodiment the said body further comprises a elastic member, an elastic force for moving the said mounting means towards the first position is applied to the said mounting means by the said elastic member.

In an embodiment, the said body further comprises two wheels arranged between the said mounting means and the said elastic member, the distance between the said two wheels is adapted for being changed and moving the said mounting means between the first position and the second position.

In an embodiment, the said mounting means is mounted to a gear rack.

In an embodiment, the said body further comprises a resistance gear, the said resistance gear is adapted to be matched with the said gear rack.

In an embodiment, the said lower face and said supporting face are made of plastic.

In an embodiment, the angle formed between the said lower face and said supporting face is between 120 degrees and 130 degrees.

In an embodiment, the distance between the first face of the said mounting means (202) and said supporting face is substantially equal to or less than 2 cm when the said mounting means (202) is at the first position.

In an embodiment, the first face of the said mounting means is in a position substantially perpendicular to the said lower face.

In an embodiment, the angle formed between the second and first faces of the said mounting means (202) is substantially equal to 90 degrees.

In an embodiment, at least one inner face of the mounting means (202) is mounted to at least one outer face of the electronic apparatus when the mounting means (202) is at the first position.

### DESCRIPTION OF DRAWINGS

This and other objects, features and advantages of the present invention will become apparent upon reading of the following detailed descriptions and drawings, in which:

FIG. 1 shows a first perspective view of an embodiment with the mounting means of the present invention;

FIG. 2 shows a second perspective view of the embodiment without the mounting means of the present invention;

FIG. 3 shows a view of the mounting means of the embodiment of the present invention;

FIG. 4 shows the mounting means with the compressed elastic member of FIG. 3; and

FIG. 5 shows the mounting means with the relaxed elastic member of FIG. 3.

### DETAILED DESCRIPTION OF THE PREFERRED EMBODIMENT

The present invention relates to a device for holding an electronic apparatus. The said electronic apparatus may be various electronic terminals such as an audio player, a video player, a mobile phone, a tablet PC, and the like. Specifically, the device of an embodiment of the present invention is adapted for receiving the electronic apparatus when the electronic apparatus is being charged, or adapted for receiving the electronic apparatus when a user is watching a video.

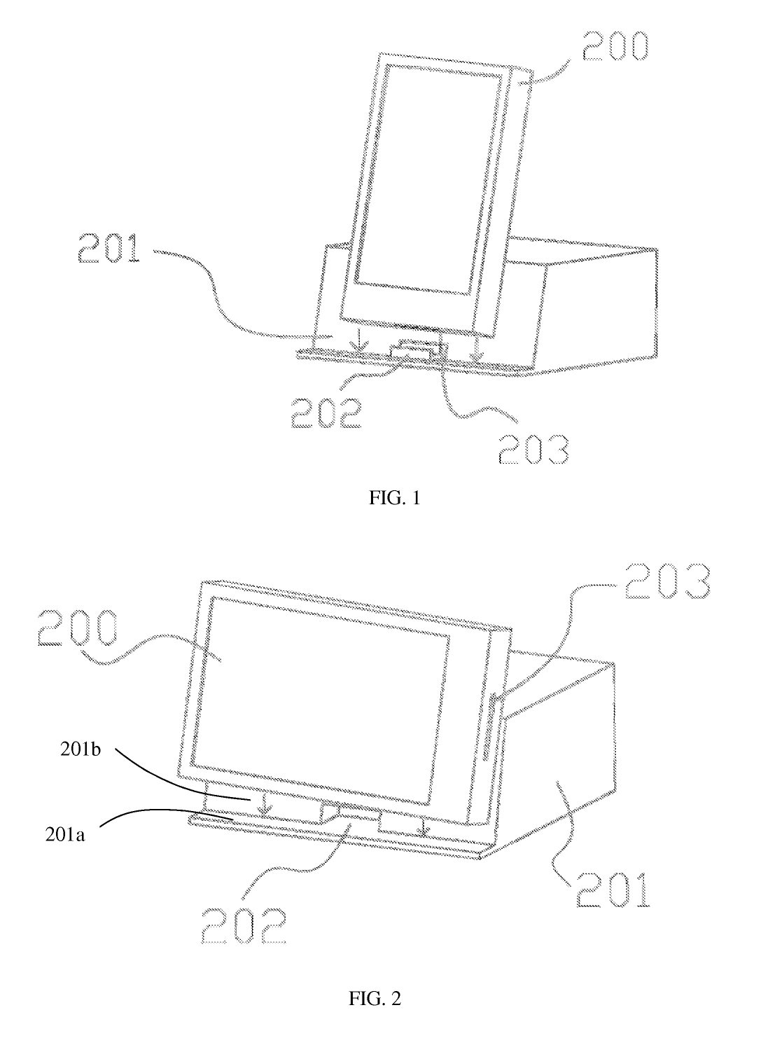

As shown in FIG. 1, the device of the embodiment comprises a body 201 and a mounting means 202. The body 201 having a supporting structure which is adapted for receiving an electronic apparatus 200. The mounting means 202 being projected from a face of the supporting structure is mounted to the body 20 is adapted to put into an interface 203 of the electronic apparatus 200 to implement communications or charging between the mounting means 202 and the electronic apparatus 200. Alternatively, the supporting structure of the body 201 is formed with a flat face. The mounting means 202 is arranged on the flat face, and is projected from the face so as to mount to the electronic apparatus 200.

In the embodiment, the mounting means 202 and the body 201 are slidingly mounted with each other. The mounting means 202 is adapted to move between a first position and a second position of the body 201.

Further, as shown in FIG. 1, when the mounting means is at the first position, the mounting means 202 is of a position which is out of the body 201 and projected from the supporting structure. As such, the mounting means is conveniently mounted to the electronic apparatus 200. Alternatively, if the interface of the electronic apparatus 200 is at the lower end, the electronic apparatus 200 is mounted to the body 201 in a way of putting the interface downwards, so that the mounting means 202 is put into the interface of the electronic apparatus 200 to implement battery charging and/or data connection.

As shown in FIG. 2 to FIG. 5, when the mounting means is at the second position, the mounting means 202 is projected from the supporting structure. Preferably, when the mounting means is at the second position, the mounting means 202 is adapted to be received inside the body 201. In the circumstances, the body 201 provides a flat supporting structure, which is convenient for a user to mount the electronic apparatus 200 to the body 201. The electronic apparatus 200 is adapted to be mounted in a vertical or horizontal position to the supporting structure. For example, the user may transversely mount the electronic apparatus 200 to the device so as to observe a widescreen film conveniently.

As mentioned above, the first position of the mounting means 202 refers to a position that the mounting means 202 is projected out. The second position of the mounting means 202 refers to a position that the mounting means 202 is received inside the body 201. That is to say, the mounting means 202 may both be under a status of being projected out and a position of being retracted back. Of course, the mounting means 202 may also be in a position between the first position and the second position, which refers to a transition status.

As shown in to FIG. 1 to FIG. 5, the supporting structure of the body 201 comprises a bottom face 201a adapted for receiving the electronic apparatus. Preferably, the bottom face 201a is a flat structure, which is convenient for the user to mount the electronic apparatus 200.

The supporting structure further comprises a supporting face 20 lb mounted to the bottom face 201a. When the electronic apparatus 200 is mounted to the device, the electronic apparatus 200 is adapted to be supported by the supporting face 201b.

In the embodiment, an angle formed by the bottom face 201a and the supporting face 201b is equal to or more than 90 degrees. In this way, when the electronic apparatus 200 is mounted to the bottom face 201a, the electronic apparatus is adapted to be supported by the supporting face 201b.

In the embodiment, when the mounting means 202 is at the first position, the mounting means 202 is of a position which is out of the supporting face 201b and projected from the bottom face 201a. As such, the user can mount the electronic apparatus having the interface positioned at the lower end of the apparatus to the body 201, the mounting means 202 is then installed into the interface of the electronic apparatus 200. The electronic apparatus 200 is adapted to be supported by the supporting face 201b.

In the embodiment, the supporting face 201b comprises an aperture adapted for the mounting means 202 being moved out and back. The body 201 further comprises an elastic member 505. The elastic member 505 is adapted for applying an elastic force on to the mounting means 202. The elastic force is adapted to allow the mounting means 202 to project out from the aperture and then move towards the first position.

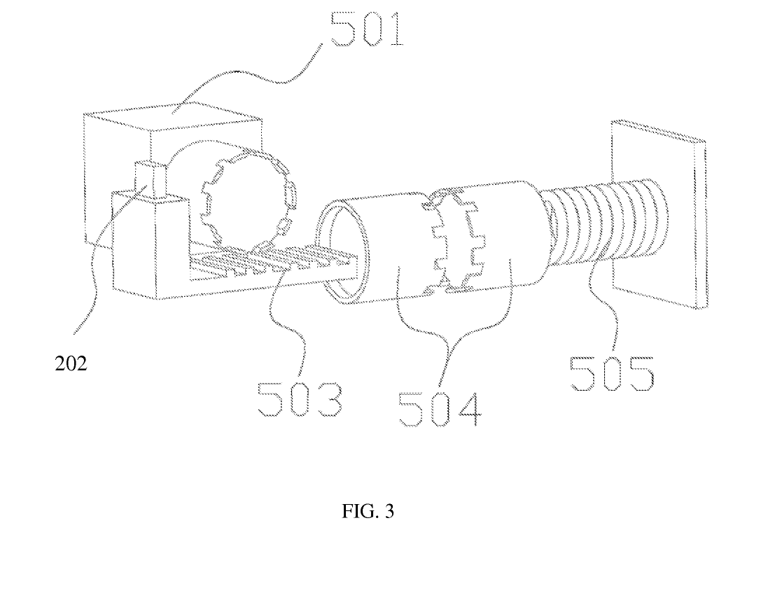

As shown in FIG. 3, two wheels 504 are arranged between the mounting means 202 and the elastic member 505. When gears of the two wheels 504 are in opposite positions, the distance between the two wheels 504 is adapted to be changed while rotating such that it allows the mounting means 202 to be moved between the first and the second positions. For example, the user pushes the mounting means 202 towards the body 201, the distance between the two wheels 504 is then shortened, and the mounting means 202 is moved back into the body 201. Alternatively, the user pushes the mounting means 202 again, the distance between the two wheels is increased to make the mounting means 202 being projected out from the body 201.

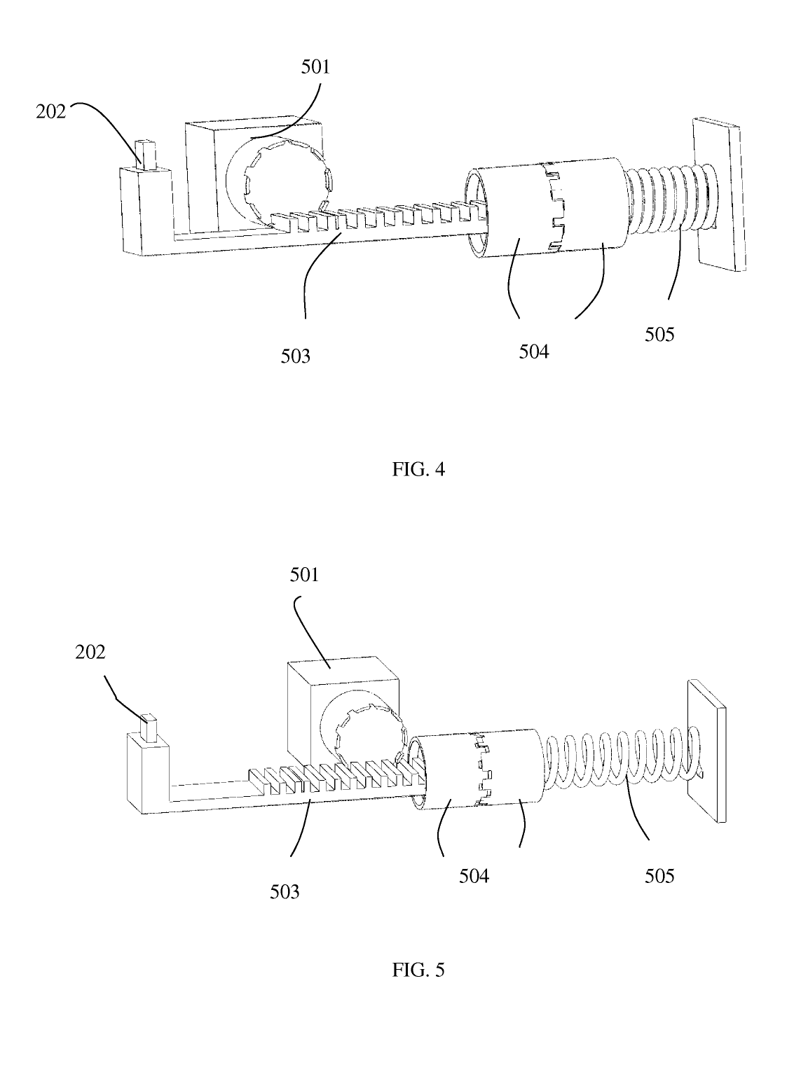

As shown in FIG. 4, when the mounting means 202 is moved into the body 201 by external force, a gear rack 503 is then driven by such pressure made by the mounting means 202 and move into the body 201. At the same time, the resistance gear 501 provides frictional force to the gear rack 503 such that the moving velocity of the gear rack 503 will then be reduced. Such a reduction of velocity allows reducing the damages and/or wearing due to striking force between the parts of the device. Further, the motion of the gear rack 503 drives the two wheels 504 to rotate and allows the gear teeth with various dimensions between the two wheels 504 being connected with each other. In this way, the pressure towards the elastic member 505 is formed by connection of the gear teeth of certain dimensions with longer length such that a pressure will be applied onto the elastic member 505. The elastic member 505 will be in a compressed condition and the mounting means 202 will then be received inside the body 201.

As shown in FIG. 5, when the external force applies to the mounting means 202 which is located inside the body 201, the two wheels 504 will then be rotated again and drive the elastic member 505 to a relaxed condition. The certain gear teeth of the two wheel 504 are connected with each other and the length of the two wheels are changed due to connection of different gear teeth. The gear rack 503 will move outwardly but will reduce the moving velocity due to the frictional force made by the resistance gear 501. The wearing and/or damages will then be reduced and the mounting means 202 will finally be positioned outside the body 201.

In the embodiment, the mounting means 202 and a gear rack 503 are mounted with each other.

In the embodiment, the body 201 comprises a resistance gear 501. The resistance gear 501 corresponds with the gear rack 503 such that the damages due to fast motion of the mounting means 202 is avoided. Alternatively, the wheels 504, the gear rack 503 and the resistance gear 501 may be made of plastics so as to reduce the material cost.

The device of the present invention is adapted to used as a mobile phone charger, a tablet computer charger, and the like.

The present invention has been described in detail, with reference to the preferred embodiment, in order to enable the reader to practice the invention without undue experimentation. However, a person having ordinary skill in the art will readily recognize that many of the previous disclosures may be varied or modified somewhat without departing from the spirit and scope of the invention. Accordingly, the intellectual property rights to this invention are defined only by the following claims.

1. The device for holding an electronic apparatus comprises a body and a mounting means, said body comprises a supporting structure configured to receive the electronic apparatus, said mounting means being movable between a first position and a second position of said body, a first face of said mounting means is projected outwardly from a face of said supporting structure when said mounting means is at the first position of the said body, said mounting means is received inside said body when said mounting means is at the second position of said body, said supporting structure comprises a supporting face mounted to a lower face of said supporting structure, said supporting face is configured to support the electronic apparatus when the electronic apparatus is abutted against the supporting face.

2. The device according to claim 1, said supporting structure comprises said lower face configured to support the electronic apparatus, said mounting means protruded upwardly from said lower face when said mounting means is at the first position, an angle formed between said lower face and said supporting face is substantially equal to or larger than 90 degrees.

3. (canceled)

4. The device according to claim 2, characterized in that said supporting face having an aperture therein to allow reception of said mounting means to pass through.

5. The device according to claim 1, wherein said body further including an elastic member coupled to said mounting means and biasing said mounting means towards the first position.

6. The device according to claim 5, further including two wheels arranged between said mounting means and said elastic member, a distance between said two wheels being changed being changeable and moving said mounting means between the first position and the second position.

7. The device according to claim 6, characterized in that said mounting means is mounted to a gear rack.

8. The device according to claim 7, characterized in that said body further comprises a resistance gear engaged with said gear rack.

9. The device according to claim 2, wherein said lower face and said supporting face are comprised of plastic.

10. The device according to claim 2, characterized in that the angle formed between said lower face and said supporting face is between 120 degrees and 130 degrees.

11. The device according to claim 10, wherein a distance between the first face of said mounting means and said supporting face is substantially equal to or less than 2 cm when the said mounting means is at the first position.

12. The device according to claim 11, characterized in that the first face of said mounting means is in a position substantially perpendicular to the said lower face.

13. The device according to claim 12, characterized in that the angle formed between second and first faces of said mounting means is substantially equal to 90 degrees.

14. The device according to claim 12, characterized in that at least one inner face of the mounting means is mounted to at least one outer face of the electronic apparatus when the mounting means is at the first position.

15. The device according to claim 4, wherein said body further including an elastic member coupled to said mounting means and biasing said mounting means towards the first position.

16. The device according to claim 15, further including two wheels arranged between said mounting means and said elastic member, a distance between said two wheels being changeable and moving said mounting means between the first position and the second position.

17. The device according to claim 16, characterized in that said mounting means is mounted to a gear rack.

18. The device according to claim 7, characterized in that said body further comprises a resistance gear engaged with said gear rack.

19. The device according to claim 4, wherein said lower face and said supporting face are comprised of plastic.

20. The device according to claim 4, characterized in that the angle formed between the said lower face and said supporting face is between 120 degrees and 130 degrees.

21. The device according to claim 20, wherein a distance between the first face of said mounting means and said supporting face is substantially equal to or less than 2 cm when said mounting means is at the first position.
